(19) United States
(12) Patent Application Publication
(10) Pub. No.: US 2008/0190159 A1
(43) Pub. Date: Aug. 14, 2008

(54) Apparatus and Process for Conversion of Biomass/Waste Into Bio-Organic Soil Enricher & Conditioner and Fuel

(75) Inventors: Ashwin Champraj Shroff, Maharashtra (IN); Mohan Chintopant Jawdekar, Maharashtra (IN)

Correspondence Address: BIRCH STEWART KOLASCH & BIRCH, PO BOX 747, FALLS CHURCH, VA, 22040-0747, US

(73) Assignee: Excel Industries Limited, Mumbai (IN)

(21) Appl. No.: 11/994,637

(22) PCT Filed: Jul. 3, 2006
(86) PCT No.: PCT/IN2006/000235

§ 371 Date: Jan. 3, 2008

(30) Foreign Application Priority Data
Jul. 5, 2005 (IN) 823/MUM/2005

(51) Int. Cl. C05F 11/00; B02C 18/00

(52) U.S. Cl. 71/23; 241/15; 241/291

(57) ABSTRACT

The present invention discloses a device and a process for conversion of biodegradable waste into organic fertilizer and fuel for heating. The organic fertilizer produced by the disclosed method provides nutrients to plants and at the same time improves moisture retaining capacity of the soil, prevents erosion and leaching.

### FIELD OF INVENTION

This invention relates to a process and device for conversion of biodegradable waste into organic-fertilizer and fuel for domestic/industrial heating. The organic fertilizer produced by this method not only provides nutrients for plants, but it also improves the organic-carbon content and moisture retaining capacity of the soil. The said fertilizer functions as an effective soil-conditioner which enhances the growth of beneficial microorganisms, which is in turn essential for plant growth.

### PRIOR ART

British patent GB2397060 describes a composter for composting household waste comprising a rotatable drum with an inlet at an upstream end thereof and an outlet at a downstream end thereof, whereby, when the composter is in use, household waste placed in the composter at the inlet is caused to progress in stages from the upstream end thereof towards the downstream end thereof where the composted household waste may be removed at the outlet. However, in such type of system the fluid from untreated waste tend to move downwards thereby contaminating the material downstream at the outlet.

JP2004089942 describes a food decomposition treatment apparatus which includes a large number of bacterial beds supporting microorganisms and arranged in the decomposition tank, a temperature regulation means for regulating the temperature in the decomposition tank and rotary shaft.

JP2003034588 discloses a device and a method which involves many steps for producing the organic fertilizer and the organic feed from food refuse comprising a weighing process, a separating process, a crushing process, a dehydrating process, a sterilizing and fermenting process, a blending process, a granulating process, and a weighing and bagging process. The operation of a circulation-chain-type recycling system is managed and controlled by with computer connected to a communication network.

TW460432 discloses a high temperature aerobic fermentation device for solid organic disposals comprising a fermentation trough for receiving high temperature aerobic bacteria; a mixing device for mixing the bacteria with the solid organic disposals, and supplying air to the mixture; exchangers etc.

EP1103313 discloses a device comprising a treatment chamber to decompose food wastes by a microorganism, exhaust airflow adjuster, a control unit, dehumidifier and deodorizer.

JP11199473 describes a device for decomposing food processing residue which includes an agitating tank into which many granular bodies are introduced and packed along with the residue. Moreover, it also includes a heating means, an air conditioning means, hot water circulating device, and a far IR heater.

A process and assembly to dry organic kitchen wastes using electro-magnetic field has been described in DE19735204. Hot air is blown through moist kitchen waste, evaporating water vapor from it. Alternatively, moist organic residues are introduced into a drying chamber in which an electro-magnetic field is generated. The electro-magnetic field is partly absorbed by the organic wastes which are heated to release water vapor.

EP0860407 discloses a fermenting and drying apparatus for food garbage comprising an air intake for continuously supplying the ferment funguses and oxygen in air to a food garbage tank, a heat-supplying device for indirectly heating the food garbage tank by heat medium, a temperature and time controller, an agitator, and an offensive odor gas-removing mechanism.

Food residue composting assembly has been disclosed in DE19749751 which consists of a housing with an air inlet and outlet fitting, a food residue cassette which fits within the housing and has an air inlet and outlet, a cassette air inlet receiving air from the housing, a cassette air outlet within the housing and an effluent air deodorizing unit with heat-operated catalyst located within a box. The deodorizer is so positioned within the air outlet so that one side of the deodorized box is exposed warming the incoming fresh air to accelerate the decomposition of the food residues.

KR9701218 discloses a device for obtaining fertilizer using waste foods, comprising compacting machine in which solid waste is separated from liquid waste by pressing and sent to a solid waste reservoir tank and liquid waste is sent to liquid waste reservoir tank, two solid waste fermenters in which the solid waste and a moisture control agent sent from a moisture control agent reservoir tank are fermented, a composite tank in which an aging agent and contents sent from two solid waste fermenters are fermented anaerobically. A crusher is provided to crush the waste liquid.

GB1380979 discloses a process and apparatus for drying and compressing garbage comprising lower and upper hot plate, feed means for placing garbage on the hot plate, and scraper means for scraping garbage from lower hot plate. Heating may be at from 212 F to 900 F. The apparatus is suitable for converting garbage, which is primarily food waste, into animal feed.

KR9610805 discloses a method and device for converting food waste into organic fertilizer. The device includes fermentation tank, a crusher connected to the fermentation tank via a sloped path having crushing blades and a drive motor, an agitator installed at a hollow shaft within the fermentation tank, having a plurality of agitation blades, the hollow shaft forming a hot air feeding path, and a plurality of nipples discharging the hot wind by a heat exchanger, and a blower.

A ferment system for waste food to obtain fertilizer has been disclosed in KR9514889, comprising collecting/fermenting device, agitator, chute and discharging outlet, a cyclone dust collector, a chemical tank, an ozone generator, and feeding roller.

KR9510611 discloses food dregs disposal and fertilizers apparatus comprising a hopper, a compost molding device, a grinding apparatus, purifying device to purify water generated from the compost molding apparatus, and a water supplying device.

An apparatus has been disclosed in KR9408622, which produces fertilizer from food waste collected in kitchens. The apparatus comprises the first cutting section having a blade of zigzag type, the second cutting section having a gateway for discharging after cutting, a precision crusher having a blade of zigzag type, a fine powder crusher, a dryer, a sorter distributing waste and reusing the material.

DE4134018 describes a composting system for organic waste material and contaminated soils which has a crane-mounted mixing head in form of grab and/or mixing rollers which move over composting material and provide continuous mixing. It incorporates a means for dosing the material with substances which promote the composting process, such as nutrients, enzymes or hydrogen peroxide. Under this system the process space can be as large as may be required, and the material is turned on a continuous basis so that lumps are broken up and the access of oxygen to the material is increased. The composting process is thereby greatly accelerated. However, the system is very huge and not suitable unless operated on large open space.

Device for changing food by-product to liquid manure by using microorganisms has been disclosed in JP6024882.

Combination of enzyme-fermentation and anaerobic bacterial fermentation for food waste has been described in JP8323328.

A food waste processing machine is described in JP7033572, which can be continuously operated by alternately charging the food waste into two tanks. A moisture-detection sensor is placed at an arbitrary position in each fermentation chamber to detect the water-content. The air blowing rate, temperature of hot air, heater temperature and stirring speed are controlled to respective optimum levels for the fermentation decomposition treatment based on the detected water content and the food waste charging tank is selected based on the water content.

### OBJECTS OF INVENTION

The main object of present invention is to provide a system which solves the problem of waste disposal and at the same time produces valuable bio-fertilizer and fuel.

Another object of the invention is to prevent the problems of odor, leachate and ground water contamination occurring due to conventional ways of waste disposal.

Another object of invention is to provide a device and process for treatment of waste which converts ugly and smelly garbage into an innocuous material which does not give foul smell and does not appear dirty or ugly.

Another object of the invention is to provide a system which avoids the waste from coming into contact with hands/body of the users.

Another object of the invention is to provide a method for bio-stabilization of organic waste thereby converting the waste into a form which does not decay or give foul odor during transportation or storage.

Another object of the invention is to prevent health hazards resulting due to decaying waste.

Another object of the invention is to prevent fire hazard due to generation of gases like methane, which is common feature of conventional method of waste disposal i.e. by dumping.

Another object of the invention is to provide a simple device and method for converting bio-degradable waste into bio-fertilizer and fuel for domestic or industrial heating.

Another object of the invention is to provide an alternate means to obtain renewable energy and thereby saving wood/forest-wealth of the nation.

Another object of the invention is to provide a system which is simple, convenient to operate, economic, maintenance free, beneficial to the environment, and which requires minimum efforts to operate without the need for constant attention.

### DESCRIPTION OF FIGURES

FIG. 1 is the side view showing the chopper assembly (15) with blades inside the container.

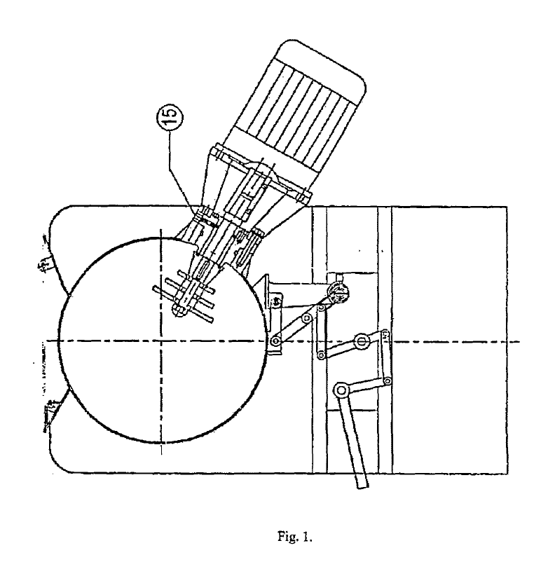

FIG. 2 shows the pulley (17, 18) and belt (16) drive.

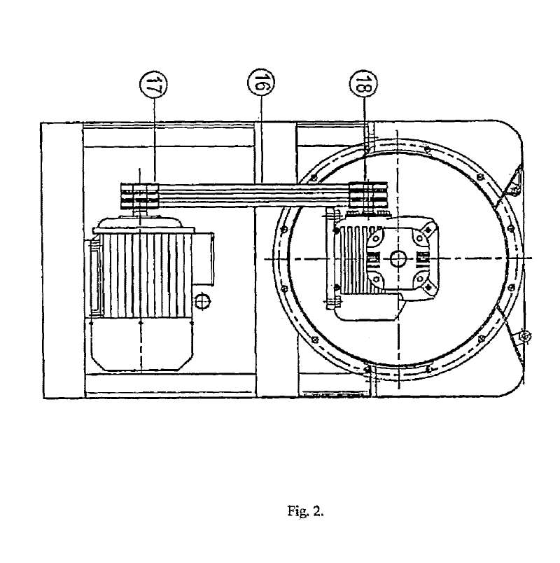

FIG. 3 is the top view of the machine showing container with door assembly (14) and chopper assemblies.

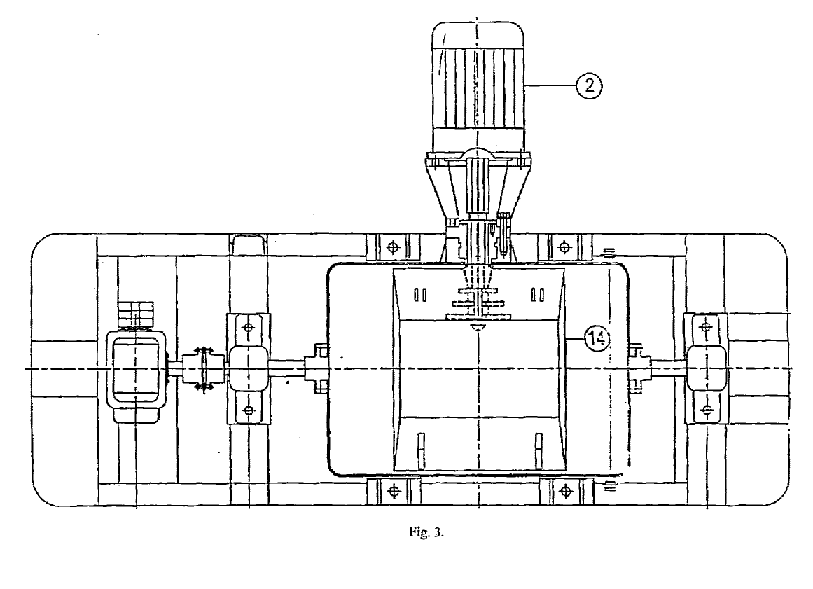

FIG. 4 is the front view of the system showing the container (9), plough type blades (11), discharge assembly (13), shaft (10), seal bush (12), control panel (20), base frame (19), motor (1, 2), gear box (3), chain coupling (4), bearing (5), adapter sleeve (6), plumer block (7), and locking ring (8).

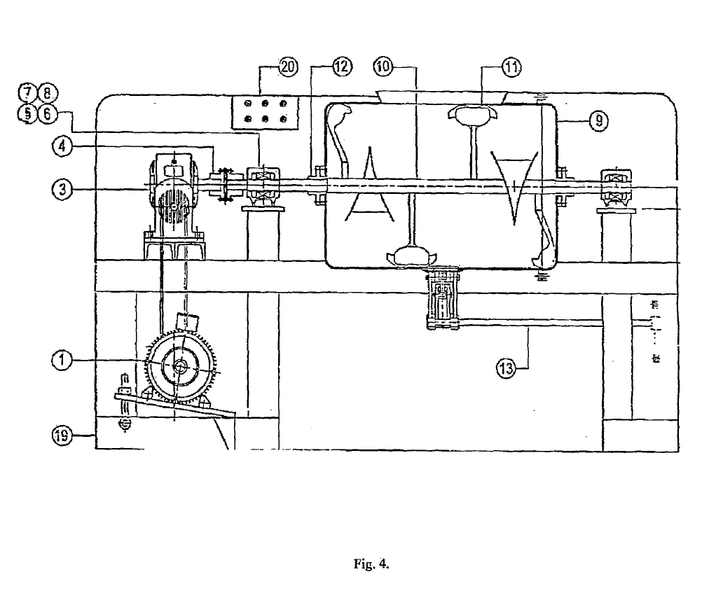

### DETAILED DESCRIPTION OF THE INVENTION

### Apparatus:

The system includes a container (9) which may be of cylindrical shape, incorporating a shaft (10) at the axis, affixed on which are plough type blades (11) moving in a circular fashion across the periphery of the container. The shaft is supported on a bearing (5) outside the container and it is driven by gear box (3) connected to a motor by a pulley (17,18) & belt (16) drive. The organic waste is fed through a door assembly (14) at the top side of the container.

To the cylindrical container, a chopper assembly (15) along with an electric motor drive is attached in an angular position at the back side of the machine. The chopper assembly consists of two or more blades to facilitate chopping of organic waste into smaller particles.

There is a discharge assembly (13) at the bottom side of the container. The discharge assembly has a closing shutter door which is operated by a lever. After processing as described in part I, the material is transferred into a movable trolley.

Provision is also made of a control panel (20) which provides a timer, temperature control, emergency stop-switch and a current indicator (ammeter).

Complete assembly is covered by a stainless steel or mild steel metal case (19).

### The Process:

### Part-I

The bio-degradable waste such as kitchen waste is collected in a container. The said container is mounted on a trolley and it can be easily shifted to the processing machine for conversion of waste into organic fertilizer or fuel pellets.

The waste is chopped for 10-20 min to make small pieces of the material. Time required for chopping depends on the nature of the material. Smaller particles generally have better reactivity and they get converted into desired material at comparatively faster rate than larger lumps.

After chopping the material, microbial culture and saw dust are added to it.

The culture contains active microorganisms which help in converting the waste into organic fertilizer. These microorganisms facilitate desirable bio-reaction and prevent the growth of pathogenic microbes. The process also prevents formation of substances and gases with foul odor.

Saw dust absorbs excess moisture and makes the material free-flowing. It also facilitates operations like turning and handling. When fuel pellets are made out of waste, saw dust also adds to the fuel value and facilitate burning. The moisture of the material is maintained between 35-45%, preferably 40% during the process.

Optionally, lignite can also be added to the material. It gives soil-like colour to the organic fertilizer.

The machine is then run for about 15 minutes to ensure even mixing of chopped waste with the culture and saw dust. The chopping and mixing process raises the temperature of the bio-mass to about 50° C.

The material is then taken out in a movable trolley.

### Preparation of Organic Fertilizer

The material taken out from the machine into the movable trolley at the end of Part-I of the process, is emptied on the ground to make a heap of approximately one meter. Material is turned every 5-6 days to ensure aerobic conditions. Temperature of the material rises up to 70° C. within 4-5 days, due to which the pathogenic microorganisms are eliminated.

It is necessary to maintain the moisture of the material to 22-30%, preferably 25%, during maturity.

After 20-22 days, the material is ready for use as an organic fertilizer. It provides organic carbon to the soil, which is necessary for plant health and growth. It also improves moisture retaining capacity of the soil and prevents soil erosion. Thus it serves as soil-conditioner. Moreover, the said organic fertilizer prevents leaching of micro nutrients from the soil.

A fraction of the material obtained at the end of Part-II of the process may be added to fresh waste and the rest of the process may be repeated. The effective quantum of the said fraction of the material thus added can be determined in such a way so as to attain the parameters described hereinabove.

### Part-III

### Preparation of Fuel Pellets

The material obtained at the end of Part-I of the process was collected in a tray. The material was spread and cut into pieces of convenient size. It was kept for sun-drying for 5-6 days.

### EXAMPLE-1

### Preparation of Organic Fertilizer

35 Kg kitchen waste was chopped in the machine for 10 min. 15 Kg saw dust, 0.1 Kg culture and 0.1 Kg lignite were added. The machine was run for 10 min for mixing. It was then taken out in a movable trolley. This process was repeated 10 times i.e., 10 charges were taken and a composite heap of about one meter height was made. The material was turned every 5^{th} day for sufficient aeration. At the end of 20 days, the material was spread on the ground for one day for drying. The weight of the final material was 232 Kg.

### Preparation of Fuel Pellets

35 Kg kitchen waste was chopped in the machine for 10 min. 15 Kg saw dust, 0.1 Kg culture and 0.1 Kg lignite were added. The machine was run for 10 min for mixing. It was then taken out in a movable trolley. The material was spread uniformly in the tray, cut into small pieces and was sun-dried to get fuel pellets.

1. An apparatus for treating biomass/organic waste comprising a container incorporating a shaft at the axis, affixed on which are plough type blades and an opening preferably at the top side for feeding the material; a chopper assembly, at least the blades of the said chopper assembly inserted into the said container; a discharge assembly preferably connected at the bottom side of the container; a door at the connecting junction of the container and the discharge assembly which can be opened and closed, the said door may be a part of the container or the discharge assembly.

2. An apparatus as claimed in claim 1, wherein the chopper assembly is connected to a motor.

3. An apparatus as claimed in claim 1, wherein the said shaft is driven clockwise or anticlockwise across its axis by a motor.

4. A process for converting bio-degradable waste/biomass material into organic fertilizer comprising feeding the said material into the container of the apparatus of claim 1 and chopping it; adding a microbial culture or substance obtained there from; optionally adding a moisture absorbing substance; running the motor for mixing, taking out the material preferably on the ground to make a heap and ensuring aerobic conditions till the material matures into an organic fertilizer.

5. A process for bio-stabilization of bio-degradable waste/biomass material comprising feeding the said material into the container of the apparatus of claim 1 and chopping it; adding a microbial culture or substance obtained there from; optionally adding a moisture absorbing substance and running the motor for mixing.

6. A process for converting bio-degradable waste/biomass material into fuel comprising bio-stabilizing the material as claimed in claim 5; optionally spreading it in a suitable mould, pressing and cutting into pieces of suitable size; drying it.

7. A process as claimed in claims 4-6, wherein the moisture absorbing substance may be saw dust.

8. A process as claimed in claim 4, wherein the moisture of the material during maturity is maintained between 15-40%, preferably 22-30% and most preferably 24-26%.

9. A process as claimed in claim 4 or 8, wherein a fraction of the material taken out at the end of the process is added to next batch in place of the microbial culture or a substance obtained there from, and rest of the process is repeated.
